(19) United States
(12) Patent Application Publication
(10) Pub. No.: US 2013/0065213 A1
(43) Pub. Date: Mar. 14, 2013

(54) SYSTEM AND METHOD FOR ADAPTING AUDIO CONTENT FOR KARAOKE PRESENTATIONS

(71) Applicants: Ping Gao, South Pasadena, CA (US); Shaomin Sharon Peng, Agoura Hills, CA (US)

(72) Inventors: Ping Gao, South Pasadena, CA (US); Shaomin Sharon Peng, Agoura Hills, CA (US)

(73) Assignee: Harman International Industries, Incorporated, Northridge, CA (US)

(21) Appl. No.: 13/231,778

(22) Filed: Sep. 13, 2011

(51) Int. Cl. G09B 15/00

(52) U.S. Cl. 434/307 A

(57) ABSTRACT

A system adapted to process non-karaoke-mode audio content for karaoke presentations is provided. An audio filter module filters a vocal portion from the non-karaoke-mode audio content to obtain filtered audio content. An audio rendering module renders the filtered audio content to generate an audio signal for output of the filtered audio content at an audio output device. A lyric acquiring module acquires lyric information associated with the non-karaoke-mode audio content. A lyric rendering module renders the lyric information to generate a display signal for display of the lyric information such that the lyric information is adapted to be displayed synchronously with the output of the filtered audio content.

### FIELD OF THE INVENTION

This invention relates to karaoke systems and in particular karaoke systems that utilize audio content for karaoke presentations.

### BACKGROUND

Karaoke systems are audio/video (A/V) systems that allow users to sing along with their favorite songs. An audio system plays recorded music and a visual display presents song lyrics to a singer who provides the vocal accompaniment to the recorded music. Singers may sing into a microphone to broadcast their performance over a public address system.

Conventional karaoke systems often require users to purchase music content specially formatted for use with the karaoke systems. This specially formatted music content includes the music track of a song but lacks the vocal portion of the song. The specially formatted music content may also be embodied in two separate tracks, a music track and a vocal track, where the vocal track is muted during a karaoke presentation. Additionally, this specially formatted music content may include the corresponding lyrics formatted for visual display. Formats that may be used with conventional karaoke systems include CD+G, MP3+G, VCD, and DVD.

In some circumstances, however, a song may not be available in a format suited for use with a karaoke system. As a result, users may desire to use music from their own personal music collection with the karaoke system. Users' own music, however, may not be formatted for use with a karaoke system. For example, users' own music may be formatted as a WAV file, MP3 file, WMA file, AAC file, etc. Because these music formats include both the music track and the vocal portion in a mixed mode, they may not be directly suited for use with a karaoke system. Further, these music formats may also lack the lyric information for display needed for a karaoke performance.

Therefore, a need exists for a system and method that adapts existing non-karaoke-mode audio content for use with an audio system to provide karaoke presentations.

### SUMMARY

A system adapted to process non-karaoke-mode audio content for karaoke presentations is provided. An audio filter module filters a vocal portion from the non-karaoke-mode audio content to obtain filtered audio content. An audio rendering module renders the filtered audio content to generate an audio signal for output of the filtered audio content at an audio output device. A lyric acquiring module acquires lyric information associated with the non-karaoke-mode audio content. A lyric rendering module renders the lyric information to generate a display signal for display of the lyric information such that the lyric information is adapted to be displayed synchronously with the output of the filtered audio content.

A method for processing non-karaoke-mode audio content for karaoke presentations is also provided. A vocal portion of the non-karaoke-mode audio content is filtered from the non-karaoke-mode audio content to obtain filtered audio content. The filtered audio content is rendered to generate an audio signal for output of the filtered audio content at an audio output device. Lyric information associated with the non-karaoke-mode audio content is acquired. The lyric information is rendered to generate a display signal for display of the lyric information such that the lyric information is adapted to be displayed synchronously with the output of the filtered audio content.

### BRIEF DESCRIPTION OF THE DRAWINGS

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic diagram of an example of an implementation of a system to adapt existing non-karaoke-mode audio content for karaoke presentations.

FIG. 2 is a flowchart of an example of an implementation of a method for adapting existing audio content for karaoke presentations.

FIG. 3A is a panogram of a sample of an original audio file showing the distribution of energy plotted against panning index and time.

FIG. 3B is a panogram of the high-frequency portion of the audio file sample of FIG. 3A after an ambience and noise reduction process.

FIG. 3C is a panogram of the low-frequency portion of the audio file sample of FIG. 3A after an ambience and noise reduction process.

### DETAILED DESCRIPTION

A system and method for adapting non-karaoke-mode audio content to be used in karaoke presentations are provided. As used in this application, “karaoke presentation” refers to the audible presentation of audio content (playback) synchronous with the visual presentation of lyrics associated with the audio content. Audio content (e.g., songs) may include both a vocal portion and a musical portion. Karaoke-mode audio content often lacks the vocal portion of a song; users provide the vocal portion by reciting lyrics during playback of the musical portion of the song. Non-karaoke-mode audio content may include both the vocal portion and the musical portion of a song and, as a result, may not be suited for karaoke presentations. Additionally, non-karaoke-mode audio content may also lack the accompanying lyrics to a song.

As seen, a system is provided in which the audio content is filtered to remove the vocal portion of the non-karaoke-mode audio content in order to adapt it for karaoke presentations. The filtered audio content thus lacks the vocal portion but still includes the musical portion of the original non-karaoke-mode audio content. The system automatically acquires the lyrics and accompanying lyric timing information for a song. The system may acquire the lyrics by identifying, for example, the song title and artist and querying a lyric database for the accompanying lyric information. The non-karaoke-mode audio content may be automatically identified using, for example, an audio fingerprinting process.

Once the vocal portion has been removed and the lyrics acquired, the system synchronously renders the lyrics with playback of the filtered audio content. Timing information included with the lyric information enables the appropriate lyrics to be rendered at the appropriate times during playback of the musical portion of the filtered audio content.

As seen, the system allows users to use music from their own music libraries for karaoke presentations. Advantageously, users who wish to perform karaoke do not need to obtain audio content specifically formatted for karaoke systems. Moreover, users can toggle the system to switch between karaoke playback and non-karaoke playback of the audio content using the non-karaoke-mode audio content for both modes. During karaoke playback, the vocal portion of the audio content is removed before playback of the musical portion of the filtered audio content; during non-karaoke playback the vocal portion is not removed.

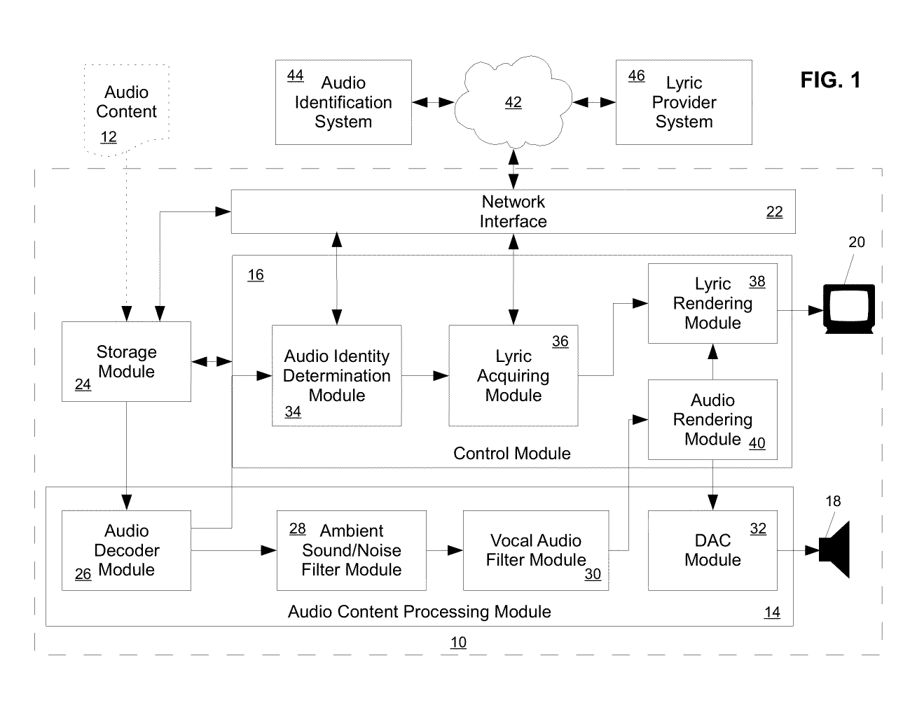

Referring to FIG. 1, a schematic diagram of an example of an implementation of a system 10 to adapt non-karaoke-mode audio-content 12 for karaoke presentations is shown. Non-karaoke-mode audio content 12 is audio content that may include both a vocal portion and a musical portion. The vocal portion of the non-karaoke-mode audio content 12 may include lyrics that can be recited during karaoke presentations. It will be understood that non-karaoke-mode audio content 12 may also include audio content that lacks a vocal portion but is nonetheless associated with accompanying lyrics.

The non-karaoke-mode audio content 12 may be in an analog or digital format. If the non-karaoke-mode audio content 12 is digital, it may be provided as a raw bitstream or contained in an audio file. Audio files may be uncompressed or compressed. Uncompressed audio files include, for example, WAV, AIFF, AU. Compressed audio files may be compressed using a lossless or lossy format. Lossless audio file formats include, for example, FLAC and Apple Lossless. Lossy audio file formats include, for example, MP3 and AAC.

In the example system of FIG. 1, the system 10 includes an audio content processing module 14 and a control module 16. The system 10 may also include an audio output device 18, a display device 20, a network interface 22, and a storage module 24.

The audio content processing module 14 decodes compressed non-karaoke-mode audio content 12, reduces ambient sounds and noise in the non-karaoke-mode audio content, filters the non-karaoke-mode to remove the vocal portion, and converts a digital audio signal into an analog audio signal for playback of the filtered audio content. Accordingly, the audio content processing module 14 may include an audio decoder module 26, an ambient sound/noise filter module 28, a vocal audio filter module 30, and a digital-to-analog converter (DAC) module 32. The modules 26-32 of the audio content processing module 14 may be, for example, one or more: microprocessors; digital signal processors (DSPs); application-specific integrated processors (ASICs); general purpose microprocessors; field-programmable gate arrays (FPGAs); or digital signal controllers. Further, the modules 26-28 may be one or more DSPs of an audio/visual receiver (AVR) or a blu-ray disc system (BDS). Accordingly, it will be understood that the system 10 may be implemented in various configurations such as: a module installed on an AVR or BDS; a singular device in signal communication with an AVR or BDS; or a singular device having its own audio content processing module 14, audio output device 18, and display device 20.

The control module 16 identifies the non-karaoke-mode audio content 12, requests lyrics for the identified audio content, and renders the lyrics and filtered audio content for playback during a karaoke presentation. The control module 16, in this example, includes an audio identity determination module 34, a lyric acquiring module 36, a lyric rendering module 38, and an audio rendering module 40. The modules 34-40 of the control module may be implemented as one or more sets of executable instructions, and the control module 16 may include one or more processing units (not shown) that are configured to execute the instructions. The processing units, for example, may be one or more central processing units (CPUs), microprocessors, and the like.

The audio output device 18 may be any device configured to produce sound from an electrical audio signal. For example, the audio output device 18 may be, but not limited to, speakers, a loudspeaker, a public address (PA) system, or headphones.

The display device 20 may be any device capable of converting electrical signals into a visually perceivable form. For example, the display device 20 may be, but not limited to, a liquid crystal display (LCD), a cathode-ray tube (CRT) display, an electroluminescent display (ELD), a heads-up display (HUD), a plasma display panel (PDP), an organic light emitting diode (OLED) display, a vacuum fluorescent display (VFD), and the like.

The system 10 may communicate with external systems across a network 42 via the network interface 22. The network interface 22 may exchange and manage communications with external systems across a network 42 using one or a combination of wired or wireless technologies. For example, the network 42 may be a packet-switched network such as, for example, the Internet, and the network interface 22 may communicate with external systems using, for example, TCP/IP. Other types of networking protocols may be selectively employed depending on the type of network.

The system 10 may communicate via the network 42 with an audio identification system 44 and a lyric provider system 46. The audio identification system 44 is configured to provide audio identification services. The system 10 may transmit a pre-selected portion of the non-karaoke-mode audio content 12 or an acoustic fingerprint for the non-karaoke-mode audio content to the audio identification system 44, and the audio identification system may provide identifying information in response (e.g., a song title, artist, and other corresponding metadata). An acoustic fingerprint may be a unique digital summary of the non-karaoke-mode audio content and may also be referred to as an audio signature.

The lyric provider system 46 is configured to provide lyric identification services. The system 10 may transmit, for example, a song title and artist to the lyric provider system 46, and the lyric provider system may provide the lyrics to the song and timing information for the lyrics in response. The system 10 may respectively transmit a portion of the non-karaoke-mode audio content (or a signature) and song/artist information the audio identification system 44 and the lyric provider system 46 in, for example, an HTTP request. Accordingly, the identifying information and lyrics may be received in, for example, an HTTP response.

The storage module 24 may store the non-karaoke-mode audio content 12 and the lyrics received at the system 10. The storage module 24 may be any non-transitory computer-readable storage medium. While the processing module 14 is configured to filter the non-karaoke-mode audio content in real-time, in some implementations, the storage module 24 may be configured to store the filtered audio content once the processing module reduces ambient sounds and noise and removes the vocal portion.

The path of the non-karaoke-mode audio content 12 through the system for playback during a karaoke presentation will now be described. As mentioned above, a user may toggle between non-karaoke-mode playback of the non-karaoke-mode audio content 12 and karaoke-mode playback of the audio content. Thus for karaoke-mode playback of the non-karaoke-mode audio content 12, a user may activate the karaoke-mode of the system 10. A user may activate karaoke-mode by, for example, actuating a switch, pressing a button, or through a graphical user interface. The user may then select the desired non-karaoke-mode audio content 12 for karaoke-mode playback.

As seen in FIG. 1, the system 10 receives the non-karaoke-mode audio content 12. The system 10 may receive streaming non-karaoke-mode audio content 12 or the system may store the non-karaoke-mode audio content in the storage module 24 as, for example, an MP3 file. Before the system 10 presents filtered audio content during a karaoke presentation, the system automatically removes the vocal portion from the non-karaoke-mode audio content 12 and retrieves the lyric information for the audio content.

If the non-karaoke-mode audio content 12 is compressed, for example as an MP3 file, the audio decoder module 26 decodes the compressed audio file to obtain uncompressed non-karaoke-mode audio content. The audio decoder module 26 may be configured to use an appropriate coder-decoder (“codec”) to decode and decompress the audio file. For example, if the audio file is encoded as an MP3 file, the audio decoder module may use an MP3 codec to decode the audio file. As users' music libraries may include audio files encoded in a variety of different formats, the audio decoder module 26 may include multiple codecs for decoding audio files of different formats. Decoded and uncompressed audio content may be referred to as raw digital audio. In its uncompressed and decoded format, the raw digital audio may be, for example, a stereo time-domain pulse-code modulated (PCM) audio signal.

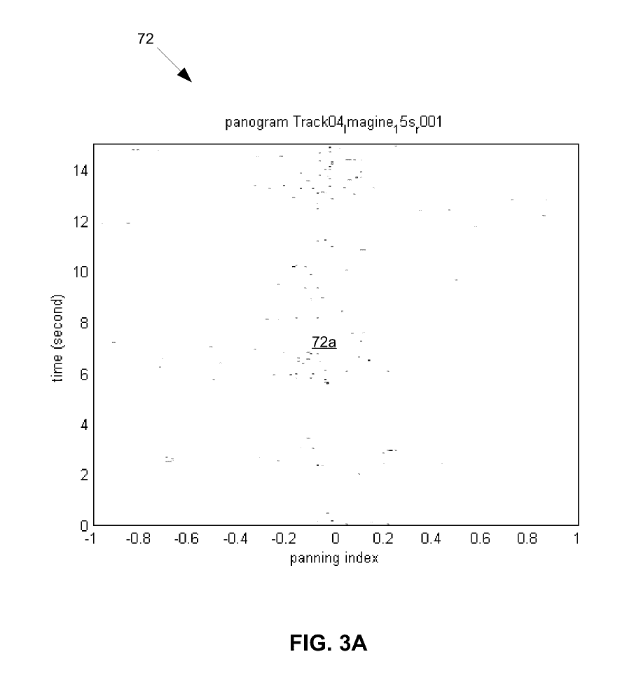

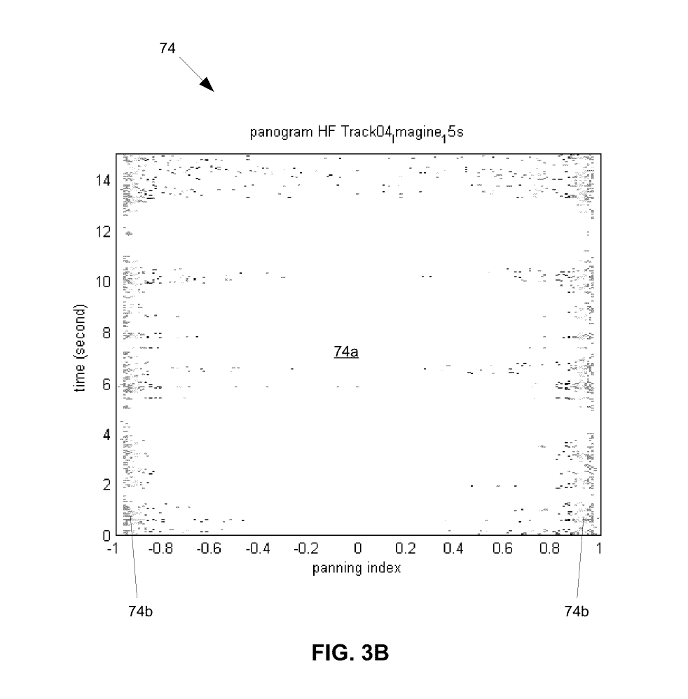

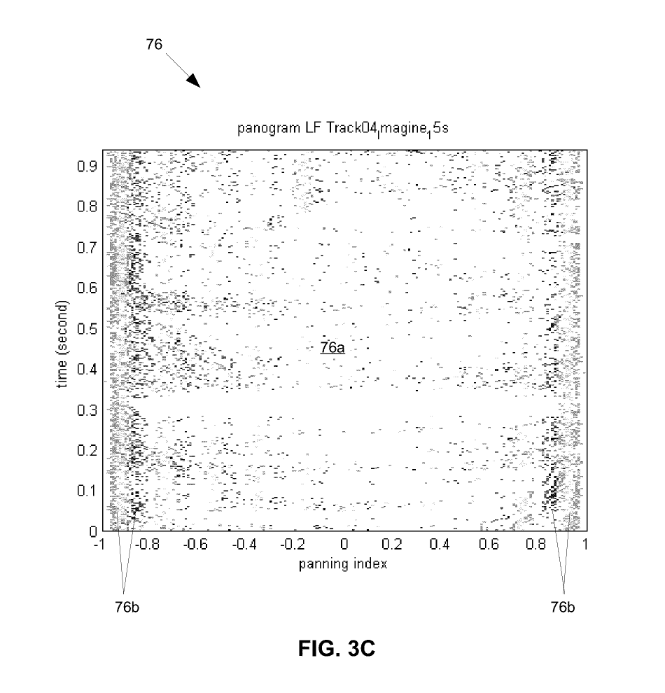

If the non-karaoke-mode audio content 12 is not compressed (or once the audio decoder module 26 has decompressed the non-karaoke-mode audio content), the system 10 filters the uncompressed non-karaoke-mode audio content to reduce ambient sounds and noise and to remove the vocal portion of the audio content. The ambient sound/noise filter module 28 conducts a time-frequency analysis to identify and reduce ambient sounds and noise in the uncompressed non-karaoke-mode audio content. At this stage, the non-karaoke-mode audio content is not yet ready for karaoke presentations as it still includes the vocal portion. The vocal audio filter module 30, in this example, then extracts the vocal portion from the uncompressed non-karaoke-mode audio content. Ambient sound/noise reduction and vocal extraction will be discussed in further detail below with reference to FIGS. 3A-C. Once the ambient sounds and noise have been reduced and the vocal portion removed, the filtered audio content is ready to be rendered for a karaoke presentation.

Before a karaoke presentation begins, however, the system 10 may retrieve the accompanying lyrics and timing information for the non-karaoke-mode audio content 12 so that the system may synchronize display of the lyrics with playback of the filtered audio content. In some circumstances, the non-karaoke-mode audio content 12 may not include the accompanying lyrics. As a result, the system 10 in FIG. 1 includes a lyric acquiring module 36 that retrieves lyrics from a lyric provider system 46 that includes a database of song lyrics and timing information respectively associated for the song lyrics.

The system 10 may be in signal communication with the lyric provider system 46 via a network 42 such as, for example, the Internet. The lyric provider system 46 may maintain a database of both lyrics and corresponding timing information for the lyrics. In this way, the system 10 that adapts non-karaoke-mode audio content for karaoke presentations may access a repository (lyric provider system 46) that provides the system with the lyric information used to adapt non-karaoke-mode audio content for karaoke presentations. The lyric acquiring module 36 may transmit a request for lyrics and corresponding timing information to the lyric provider system 46 in, for example, an HTTP request. The request may specify a desired song and corresponding artist as well as other metadata relating to the audio content that can be used to identify the audio content. The lyric provider system 46 may query its lyric database for a record that matches the song, artist, and metadata specified in the request. The lyric provider system 46 may transmit the lyrics and the corresponding timing information for the lyrics of a matching record in, for example, an HTTP response. The system 10 may store the lyrics received from the lyric provider system 46 in the storage module 24. In this way, the system 10 may subsequently retrieve the lyrics from the storage module 24 rather than request the lyrics from the lyric provider system 46 for each karaoke presentation. In some instances, an audio file for the non-karaoke-mode audio content 12 may include lyric information as metadata or in an associated lyric file. As a result, the lyric acquiring module 36 may retrieve the lyrics from the metadata of the audio file or the lyric file rather than retrieve the lyrics from the lyric provider system 46.

To request lyrics from the lyric provider system 46, the lyric acquiring module 36 may need to know the song title, artist, and other metadata associated with the non-karaoke-mode audio content 12. In some situations, an audio file for the non-karaoke-mode audio content 12 may include the song title, artist, and other information as supplemental data in the header of the audio file or as metadata. In this circumstance, the lyric acquiring module 36 may use this information when requesting lyrics from the lyric provider system 46.

In other situations, however, the non-karaoke-mode audio content 12 may not identify the song title or artist. In these circumstances, the audio identity determination module 34 may automatically identify the non-karaoke-mode audio content 12. For example, the audio identity determination module 34 may automatically identify the non-karaoke-mode audio content 12 using audio fingerprinting. Audio fingerprinting is a form of digital file identification in which audio content is identified from a portion of the audio content or from an acoustic fingerprint of the audio content. One example of an audio fingerprinting service that may be selectively employed is available from Gracenote, Inc. in Emeryville, Calif. Additional or alternative techniques may be selectively employed to identify the non-karaoke-mode audio content 12.

In the example system of FIG. 1, the audio identity determination module 34 is in signal communication with the lyric acquiring module 36 and may identify the non-karaoke-mode audio content 12 from a portion (or signature) of the audio content itself using audio fingerprinting. The audio identity determination module 34 may select a portion of the uncompressed non-karaoke-mode audio content 12 for the audio fingerprinting process. The selected portion may be, for example, a 10-15 second period of the uncompressed non-karaoke-mode audio content 12. Additionally or alternatively, the system 10 itself may determine an acoustic fingerprint for the non-karaoke-mode audio content 12. The audio identity determination module 34 may transmit the selected portion of audio content or the acoustic fingerprint to an audio identification system 44 that includes a database of songs, corresponding metadata, and respective acoustic fingerprints. The system 10 may be in signal communication with the audio identification system 44 via a network 42 (e.g., the Internet) and transmit the selected portion of audio content or acoustic fingerprint to the audio identification system in an HTTP request.

Gracenote Inc., mentioned above, is one example of a service provider that provides audio identification and audio fingerprinting services via audio identification systems. The audio identification system 44 may receive the selected portion of audio content or the acoustic fingerprint from the system 10. In response to receipt of the selected portion of audio content, the audio identification system 44 may analyze the selected portion of audio content and determine an acoustic fingerprint for the selected portion. The audio identification system 44 may then match the acoustic fingerprint to a stored acoustic fingerprint in the song database. The song database may also store the song title, artist, and corresponding metadata for the song associated with the acoustic fingerprint. The audio identification system 44 may transmit to the system 10 the song title, artist, and corresponding metadata for a matching acoustic fingerprint in, for example, an HTTP response. The song database of the audio identification system 44 may also store a unique identifier for each song. Accordingly, instead of transmitting the song title, artist, and metadata, the audio identification system 44 may additionally or alternatively transmit to the system 10 the unique identifier for the matching song. Once the audio identity determination module 34 receives the song title and artist information, the audio identity determination module may provide this information to the lyric acquiring module 36. In turn, the lyric acquiring module 36 may retrieve the lyrics for the non-karaoke-mode audio content 12 from the lyric provider system 46 as discussed above.

With the filtered audio content and the accompanying lyrics, the system 10 simultaneously renders the lyrics and filtered audio content during a karaoke presentation. As seen in FIG. 1, the control module 16 includes a lyric rendering module 38 and an audio rendering module 40. The lyric rendering module 38 in FIG. 1 is in signal communication with the lyric acquiring module 36 and the display device 20 that visually displays the rendered lyrics. The lyric rendering module 38 may receive the lyrics for the non-karaoke-mode audio content 12 from the lyric acquiring module 36 or, additionally or alternatively, from the storage module 24 of the system. The audio rendering module 40, in the example shown, is in signal communication with the vocal portion filter module 30, the lyric rendering module 38, and the DAC module 32 of the audio content processing module 14. The audio rendering module 40 receives the filtered audio content from the audio content processing module 14. The DAC module 32, in this example, is in signal communication with the audio output device 18 for playback of the rendered audio.

During playback of the filtered audio content, the audio rendering module 40 supplies audio data from the filtered audio content to the DAC module 32 at the appropriate sampling rate. The DAC module 32 converts the filtered audio content from its digital form to an analog signal, and the audio output device 18 converts the analog signal to sound. As the filtered audio content is audibly presented at the audio output device 18, the appropriate lyrics are visually presented at the display device 20.

In order to achieve audio and visual synchronization, the audio rendering module 40 in FIG. 1 supplies the lyric rendering module 38 with timing information related to the rendering of the filtered audio content. The timing information supplied by the audio rendering module 40 in FIG. 1 may be, for example, a timing signal that indicates the length of time that has elapsed since the audio rendering module initiated rendering of the filtered audio content. For example, the audio rendering module 40 in FIG. 1 continually tracks how long it renders the filtered audio content and transmits this timing information to the lyric rendering module 38.

The lyric rendering module 38 compares the timing information received from the audio rendering module 40 to timing information associated with the lyrics for the non-karaoke-mode audio content 12. Lyric information may be contained, for example, in a lyric file. An example lyric file that may be used to store lyric information is the LRC file format. A lyric file may include the lyrics for the associated non-karaoke-mode audio content and time tags respectively associated with each line of lyrics. The time tags may be formatted, for example, to indicate the minute, second, and hundredth of a second (e.g., [mm:ss.xx]) at which to display the associated lyric.

The timing information and time tags may be used to synchronize display of the lyrics with playback of the filtered audio content. When a time tag matches the timing information, the lyric rendering module 38 converts the lyrics associated with the matching time tag into a display signal and transmits the display signal to the display device 20 for visual display of the lyrics.

The audio rendering module 40 in FIG. 1 continually transmits timing information to the lyric rendering module 38 throughout playback of the filtered audio content. In turn, the lyric rendering module 38 continually compares the timing information received from the audio rendering module 40 to the time tags associated with the lyrics for the non-karaoke-mode audio content 12. In this way, the system displays and highlights appropriate lyrics at the appropriate moment during playback of the filtered audio content. A user may follow the displayed lyrics and provide the vocal portion of the filtered audio content during a karaoke presentation. When the user is finished, the user may toggle the system back to a non-karaoke-mode for non-karaoke playback of the non-karaoke-mode audio content 12 in which the system does not remove the vocal portion of the audio content before playback.

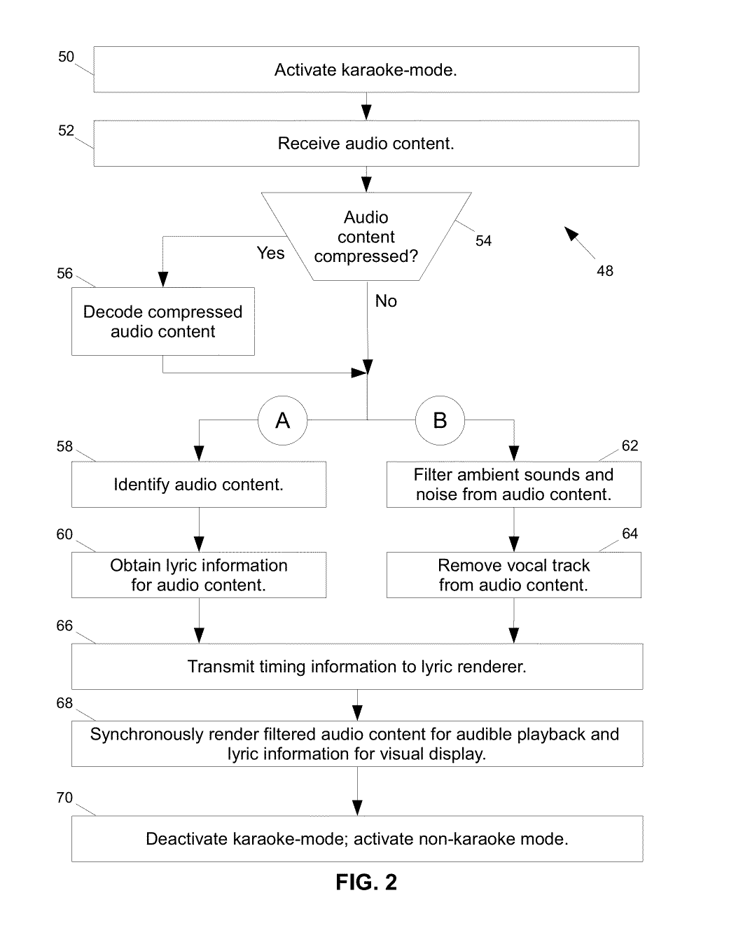

Referring now to FIG. 2, a flowchart of one example 48 for adapting non-karaoke-mode audio content for karaoke presentations is shown. Initially, a karaoke mode is activated in step 50 such that the vocal portion of the non-karaoke-mode audio content will be removed before playback of the audio content. Non-karaoke-mode audio content is received at the system for processing in step 52. As mentioned above, the non-karaoke-mode audio content may be provided as a raw bit stream or as an uncompressed or compressed audio file. If the non-karaoke-mode audio content is compressed (step 54), the compressed audio content is decoded to obtain uncompressed non-karaoke-mode audio content (i.e., raw digital audio) in step 56.

In this example, the raw digital audio is then processed along two paths, path A and path B, to convert the non-karaoke-mode audio content for a karaoke presentation. Along path A, the non-karaoke mode audio content is automatically identified in step 58. For example, the non-karaoke-mode audio content may be identified using audio fingerprinting as discussed above.

Once the non-karaoke-mode audio content is identified, lyric information for the identified audio content is acquired in step 60. As discussed above, the lyric information may be acquired from a lyric file stored in a storage module or requested from a lyric provider system.

As seen in FIG. 2, when the processing is taken along path B, raw digital audio is filtered to reduce ambient sounds and noise in the non-karaoke-mode audio content (step 62) as well as to remove the vocal portion from the non-karaoke-mode audio content (step 64). The filtered audio content that results is thus ready for playback during a karaoke presentation. During playback of the filtered audio content, timing information is transmitted to the lyric rendering module in step 66. As discussed above, this timing information is used to simultaneously render the filtered audio content for audible playback and the lyrics for visual display in step 68. When the karaoke presentation is completed, the karaoke-mode may be deactivated and the non-karaoke-mode may be activated in step 70. Non-karaoke-mode may be activated such that the vocal portion of the non-karaoke-mode audio content is not removed before playback of the audio content.

Referring now to FIGS. 3A-C, ambient sound/noise reduction and vocal extraction will be discussed in further detail. FIG. 3A is a panogram 72 of a sample audio file that plots the distribution of energy 72a against panning index and time. As seen in the panogram of FIG. 3A, it is difficult to identify the vocal content of the audio sample. The audio processing module uses time-frequency analysis to identify ambient sounds/noise and the vocal portion in the audio file. As mentioned above, the uncompressed and decoded non-karaoke-mode audio content may be a stereo time-domain PCM audio signal. The stereo time-domain PCM audio signal may include both left channel data and right channel data.

The ambient sound/noise filter module 28 may include a finite impulse response (FIR) filter (not shown) that separates the high-frequency (HF) portion and the low-frequency (LF) portion from the stereo time-domain PCM audio signal. The ambient sound/noise filter module 28 may then apply an overlapping Hanning window to the left and right channel of HF and LF data. The ambient sound/noise filter module 28 may then perform a short-time (or short-term) Fourier transform (STFT) on each of the windowed high-frequency and low-frequency signals. Because the audio signal is a stereo audio signal, the ambient sound/noise filter module 28 assumes that the levels of ambience and noise on left and right channel is equal. In turn, the ambient sound/noise filter module 28 derives an ambience/noise extraction mask for each channel.

FIG. 3B and FIG. 3C respectively illustrate the distribution of energy 74a-76a in the HF portion and LF portion of the audio sample after the ambient sound/noise filter module applies the ambience/noise reduction mask. As seen in FIGS. 3B-C, there is significantly more energy 74b-76b at particular panning indices: −0.96 and 0.96 in this example. The higher distribution of energy at these panning indices corresponds to the vocal content of the audio sample. Panning index is a function of auto-correction and cross-correlation of the left and right channel data. The vocal audio filter module 30 calculates the panning indices and then calculates the weighted exponential values of the panning indices. The vocal audio filter module 30 then applies the weighted exponential values of the panning indices as a mask to remove the vocal content from the audio. With the vocal content removed from the audio, the non-karaoke mode audio content is adapted for a karaoke presentation.

It will be understood and appreciated that one or more of the processes, sub-process, and process steps described in connection with FIGS. 1-2 may be performed by hardware, software, or a combination of hardware and software on one or more electronic or digitally-controlled devices. The software may reside in a software memory (not shown) in a suitable electronic processing component or system such as, for example, one or more of the functional systems, devices, components, modules, or sub-modules schematically depicted in FIG. 1. The software memory may include an ordered listing of executable instructions for implementing logical functions (that is, “logic” that may be implemented with in digital form such as digital circuitry or source code, or in analog form such as analog source such as an analog electrical, sound, or video signal). The instructions may be executed within a processing module, which includes, for example, one or more microprocessors, general purpose processors, combinations of processors, DSPs, or ASICs. Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

The executable instructions may be implemented as a computer program product and selectively embodied in any non-transitory computer-readable storage medium for use by or in connection with an instruction execution system, apparatus, or device, such as a computer-based system, processor-containing system, or other system that may selectively fetch the instructions from the instruction execution system, apparatus, or device and execute the instructions. In the context of this document, computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, Flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program can be electronically captured via, for instance, optical scanning of the paper or other medium, then compiled, interpreted, or otherwise processed in a suitable manner if necessary, and then stored in a computer memory or machine memory.

It will also be understood that the term “in signal communication” as used in this document means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A system that processes non-karaoke-mode audio content for karaoke presentations comprising:
an audio filter module that filters a vocal portion from the non-karaoke mode audio content to obtain filtered audio content;
an audio rendering module that renders the filtered audio content to generate an audio signal for output of the filtered audio content at an audio output device;
a lyric acquiring module that acquires lyric information associated with the non-karaoke-mode audio content; and
a lyric rendering module that renders the lyric information to generate a display signal for display of the lyric information such that the lyric information is adapted to be displayed synchronously with the output of the filtered audio content.

2. The system of claim 1 where the system is adapted to switch between a karaoke-mode and a non-karaoke-mode such that:
in the karaoke-mode, the vocal portion of the non-karaoke mode audio content is removed for a karaoke presentation; and
in the non-karaoke-mode, the vocal portion of the non-karaoke-mode audio content is not removed for a non-karaoke presentation.

3. The system of claim 1 where the lyric information is displayed on a display device synchronous with output of the filtered audio content at the audio output device.

4. The system of claim 3 where:
the audio rendering module is in signal communication with the lyric rendering module;
the audio rendering module transmits timing information to the lyric rendering module as the audio rendering module renders the filtered audio content; and
the lyric rendering module uses the timing information to synchronously render the lyric information such that the lyric information is displayed synchronously with output of the filtered audio content.

5. The system of claim 4 where:
the lyric information includes one or more lyrics for the non-karaoke mode audio content and timing information respectively associated with the one or more lyrics;
the lyric rendering module continually compares timing information received from the audio rendering module to the timing information associated with the one or more lyrics; and
when the timing information of the lyric information matches the timing information received from the audio rendering module, the lyric rendering module renders one or more of the lyrics associated with the matching timing information.

6. The system of claim 1 where:
the lyric acquiring module is in signal communication with a lyric storage system that stores lyric information, where the lyric information stored at the lyric storage module includes one or more lyrics and timing information respectively associated with the one or more lyrics; and
the lyric acquiring module retrieves lyric information from the lyric storage system.

7. The system of claim 6 where:
the lyric acquiring module transmits, to the lyric storage system via a network connection, a request for lyric information that is associated with the non-karaoke mode audio content; and
the lyric acquiring module receives the lyric information associated with the non-karaoke-mode audio content in response to receipt of the request at the lyric storage system.

8. The system of claim 1 further comprising an audio identity determination module that obtains identifying information that identifies the non-karaoke-mode audio content.

9. The system of claim 8 where the audio identity determination module obtains the identifying information via acoustic fingerprinting.

10. The system of claim 9 where:
the audio identity determination module transmits a portion of the non-karaoke-mode audio content or an acoustic fingerprint of the non-karaoke-mode audio content to an audio identification system that is adapted to perform acoustic fingerprinting via a network connection; and
the audio identity determination module receives the identifying information in response to receipt of the sample or the acoustic fingerprint at the audio identification system.

11. The system of claim 1 where the filter module filters ambient sounds or noise from the non-karaoke-mode audio content.

12. The system of claim 1 where the non-karaoke-mode audio content is in a compressed format and further comprising a decoder that decodes the compressed non-karaoke-mode audio content to obtain uncompressed non-karaoke-mode audio content.

13. The system of claim 1 where the audio filter module conducts a time-frequency analysis to identify the vocal portion of the non-karaoke-mode audio content and applies a panning index mask to remove the identified vocal portion from the non-karaoke-mode audio content.

14. The system of claim 13 where the audio filter module is implemented in one or more digital signal processors (DSPs).

15. The system of claim 1 where the non-karaoke-mode audio content is in at least one of an audio CD format, an MP3 format, an AAC format, and a WMA format, an AC3 format, an Ogg Vorbis format, a FLAC format, and an ALAC format.

16. A method for processing non-karaoke-mode audio content for karaoke presentations comprising:
filtering a vocal portion from the non-karaoke-mode audio content to obtain filtered audio content;
rendering the filtered audio content to generate an audio signal for output of the audio content at an audio output device;
acquiring lyric information associated with the non-karaoke-mode audio content; and
rendering the lyric information to generate a display signal for display of the lyric information such that the lyric information is adapted to be displayed synchronously with the output of the filtered audio content.

17. The method of claim 16 further comprising switching between a karaoke-mode and a non-karaoke mode such that:
in the karaoke-mode, the vocal portion of the non-karaoke-mode audio content is removed for a karaoke presentation; and
in the non-karaoke-mode, the vocal portion of the non-karaoke-mode audio content is not removed for a non-karaoke presentation.

18. The method of claim 16 further comprising displaying the lyric information on a display device synchronous with output of the filtered audio content at the audio output device.

19. The method of claim 18 further comprising:
receiving timing information as the filtered audio content is rendered; and
utilizing the timing information to synchronously render the lyric information such that the lyric information is displayed synchronously with output of the filtered audio content.

20. The method of claim 19 where the lyric information includes one or more lyrics for the non-karaoke-mode audio content and timing information respectively associated with the one or more lyrics and further comprising:
continually comparing received timing information to the timing information respectively associated with the one or more lyrics; and
when the timing information of the lyric information matches the received timing information, rendering one or more of the lyrics associated with the matching timing information.

21. The method of claim 16 further comprising:
storing lyric information in a lyric storage system, where the lyric information stored at the lyric storage module includes one or more lyrics and timing information respectively associated with the one or more lyrics; and
retrieving lyric information stored in the lyric storage system.

22. The method of claim 21 further comprising:
transmitting, to the lyric storage system via a network, a request for lyric information that is associated with the non-karaoke-mode audio content; and
receiving the lyric information associated with the non-karaoke-mode audio content in response to receipt of the request at the lyric storage system.

23. The method of claim 16 further comprising obtaining identifying information that identifies the non-karaoke-mode audio content.

24. The method of claim 23 where the identifying information is obtained via acoustic fingerprinting.

25. The method of claim 24 further comprising:
transmitting a sample of the non-karaoke-mode audio content or an acoustic fingerprint of the non-karaoke mode audio content to an audio identification system that is adapted to perform acoustic fingerprinting via a network connection; and
receiving the identifying information in response to receipt of the sample or the acoustic fingerprint at the audio identification system.

26. The method of claim 16 further comprising filtering ambient sounds or noise from the non-karaoke-mode audio content.

27. The method of claim 16 where the non-karaoke mode audio content is in a compressed format and further comprising decoding the compressed non-karaoke-mode audio content to obtain uncompressed non-karaoke-mode audio content.

28. The method of claim 16 further comprising:
conducting time-frequency analysis to identify the vocal portion of the non-karaoke mode audio content; and
applying a panning index mask to remove the identified vocal portion from the non-karaoke-mode audio content.

29. The method of claim 28 where the time-frequency analysis and application of ambience/noise extraction mask and vocal extraction mask is performed by one or more digital signal processors (DSPs).

30. The method of claim 16 where the non-karaoke-mode audio content is in at least one of an audio CD format, an MP3 format, an AAC format, a WMA format, an AC3 format, an Ogg Vorbis format, a FLAC format, and an ALAC format.
